(19) United States
(12) Patent Application Publication
(10) Pub. No.: US 2024/0212595 A1
(43) Pub. Date: Jun. 27, 2024

(54) DISPLAY PANEL AND DRIVING METHOD THEREFOR, GAMMA TUNING METHOD, AND DISPLAY DEVICE

(71) Applicants: Chengdu BOE Optoelectronics Technology Co., Ltd., Chengdu, Sichuan (CN); BOE Technology Group Co., Ltd., Beijing (CN)

(72) Inventors: Yong YU, Beijing (CN); Zhenwen HU, Beijing (CN)

(21) Appl. No.: 18/556,266

(22) PCT Filed: Oct. 22, 2021
(86) PCT No.: PCT/CN2021/125630

§ 371 Date: Oct. 19, 2023

(30) Foreign Application Priority Data
Apr. 20, 2021 (CN) 202110423536.4

(51) Int. Cl. G09G 3/3225

(52) U.S. Cl. CPC G09G 3/3225; G09G 2310/0262; G09G 2320/0626; G09G 2320/0673; G09G 2330/021; G09G 2360/14

(57) ABSTRACT

Provided are a display panel and a driving method therefor, a gamma tuning method, and a display device. Pixels in the display panel are arranged in an array. The display panel includes multiple display sub-regions in a row direction of the array. The display panel further includes: scan lines, including multiple scan sub-lines that control a same pixel row, the multiple scan sub-lines having a one-to-one correspondence to the multiple display sub-regions; scan driving circuits, configured to provide scan signals to corresponding pixel rows; and switch circuits. Each switch circuit is electrically connected between two adjacent scan sub-lines in a same scan line. When the switch circuit is configured to be in an off state, frequencies of scan signals output by the scan driving circuits to at least some scan sub-lines in the same scan line are different.

### CROSS REFERENCE TO RELATED APPLICATION

The present application is a National Stage of International Application No. PCT/CN2021/125630, filed Oct. 22, 2021, which claims the priority to Chinese patent application No. 202110423536.4, filed with China National Intellectual Property Administration on Apr. 20, 2021 and entitled “DISPLAY PANEL AND DRIVING METHOD THEREFOR, GAMMA TUNING METHOD, AND DISPLAY DEVICE”, the entire content of which is incorporated herein by reference.

### TECHNICAL FIELD

The present disclosure relates to the field of display technologies, and in particular, to a display panel and a driving method therefor, a gamma tuning method, and a display device.

### BACKGROUND

With the continuous maturity of active matrix/organic light emitting diode (AMOLED) technology, in order to minimize left and right bezels of a panel, a gate drive on array (GOA) circuit is used instead of a traditional line scan control circuit.

In a small and medium-sized display product (such as a mobile phone), in order to improve the driving capability of the GOA circuit, bilateral GOA circuits (i.e., two columns of GOA circuits are arranged on two sides of the display region, and two ends of one same scan line are electrically connected to GOA output terminals at two sides of the row of the scan line respectively, and signals output by the two GOA output terminals are the same) are usually used to drive a display screen.

With the enhancement of entertainment attributes of products such as mobile phones, it is required that such products can support multiple frequencies for image display in order to adapt to different display modes. When a higher frequency is used for display, the power consumption is usually larger.

### SUMMARY

Embodiments of the present disclosure provide a display panel, a driving method for the display panel, a gamma tuning method, and a display device, so as to solve the above-mentioned problems in the prior art.

In a first aspect, in order to solve the above technical problems, embodiments of the present disclosure provides a display panel, wherein: pixels in the display panel are arranged in an array, the display panel includes a plurality of display sub-regions in a row direction of the array, and the display panel further includes:
a plurality of scan lines, including a plurality of scan sub-lines that control a same pixel row, wherein the plurality of scan sub-lines correspond to the plurality of display sub-regions one-to-one;
a plurality of scan driving circuits, configured to provide scan signals to corresponding pixel rows; and
a plurality of switch circuits, wherein each of the plurality of switch circuits is electrically connected between two scan sub-lines adjacent to each other in a same scan line, and when the switch circuit is configured to be in an off state, frequencies of scan signals output by the scan driving circuits to at least part of different scan sub-lines in the same scan line are different.

In possible implementations, multiple switch circuits, of the plurality of switch circuits, between two display sub-regions adjacent to each other are in a linear arrangement.

In possible implementations, the linear arrangement includes arrangement along a line parallel to a column direction of the array.

In possible implementations, the linear arrangement includes arrangement along an oblique line intersecting the column direction.

In possible implementations, multiple switch circuits, of the plurality of switch circuits, between two display sub-regions adjacent to each other are in a non-linear arrangement.

In possible implementations, areas of the plurality of display sub-regions are different.

In possible implementations, areas of the plurality of display sub-regions are the same.

In possible implementations, the switch circuit includes a thin film transistor, and a first terminal and a second terminal of the thin film transistor are electrically connected to one terminal of one of the two scan sub-lines adjacent to each other in the scan line and one terminal of the other of the two scan sub-lines.

In possible implementations, control terminals of multiple thin film transistors between two display sub-regions adjacent to each other are electrically connected to a same signal control terminal.

In a second aspect, embodiments of the present disclosure provide a driving method for a display panel according to the first aspect, including:
setting, according to a quantity of types of frequencies of the scan signals outputted by the plurality of scan driving circuits in the display panel for a same frame image, working states corresponding to the plurality of switch circuits; wherein the working state include an on state or an off state.

In possible implementations, the setting, according to the quantity of types of frequencies of the scan signals outputted by the plurality of scan driving circuits in the display panel for the same frame image, the working states corresponding to the plurality of switch circuits includes:
setting, when the quantity of types of frequencies of the scan signals outputted by the plurality of scan driving circuits in the display panel for the same frame image is one, the working states of the plurality of switch circuits to the on states.

In possible implementations, the setting, according to the quantity of types of frequencies of the scan signals outputted by the plurality of scan driving circuits in the display panel for the same frame image, the working states corresponding to the plurality of switch circuits includes:
setting, when the quantity of types of frequencies of the scan signals outputted by the plurality of scan driving circuits in the display panel for the same frame image is multiple, the working states of the plurality of switch circuits to the off states.

In possible implementations, the setting, when the quantity of types of frequencies of the scan signals outputted by the plurality of scan driving circuits in the display panel for the same frame image is multiple, the working states of the plurality of switch circuits to the off state includes:
setting, when the quantity of types is equal to a quantity of the plurality of display sub-regions, working states of all the plurality of switch circuits to the off state;
when the quantity of types is less than a quantity of the display sub-regions: setting working states of switch circuits between adjacent display sub-regions in which frequencies of scan signals are the same to the on state, and working states of switch circuits between adjacent display sub-regions in which frequencies of scan signals are different to the off state.

In a third aspect, embodiments of the present disclosure provide a gamma tuning method for a display panel according to the first aspect. The gamma tuning method includes:
configuring the plurality of switch circuits in the display panel to be in an off state, so as to divide a display region of the display panel into the plurality of display sub-regions;
controlling an image to be displayed in the respective display sub-regions at different refresh frequencies; and
performing gamma tuning on the respective display sub-regions at the same time; wherein each of the plurality of display sub-regions corresponds to one optical detection probe, and the optical detection probe is configured to detect brightness of a corresponding display sub-region, so as to perform the gamma tuning.

In a fourth aspect, embodiments of the present disclosure provide a display device, including the display panel as described in the first aspect.

### BRIEF DESCRIPTION OF FIGURES

FIG. 1 is a schematic structural diagram of a display panel in the related art.

FIG. 2 is a schematic structural diagram of a display panel according to an embodiment of the present disclosure.

FIG. 3 is a schematic structural diagram of another display panel according to an embodiment of the present disclosure.

FIG. 4 is a schematic diagram of multiple switch circuits in an oblique line arrangement according to an embodiment of the present disclosure.

FIG. 5 is a schematic diagram of multiple switch circuits in a linear arrangement according to an embodiment of the present disclosure.

FIG. 6 is a schematic diagram of multiple switch circuits in a non-linear arrangement according to an embodiment of the present disclosure.

FIG. 7 is a schematic structural diagram of another display panel according to an embodiment of the present disclosure.

FIG. 8 is a flowchart of a gamma tuning method for a display panel according to an embodiment of the present disclosure.

FIG. 9 is a schematic diagram of a corresponding relationship between optical detection probes and display sub-regions of a display panel according to an embodiment of the present disclosure.

### DETAILED DESCRIPTION

Embodiments of the present disclosure provide a display panel, a driving method therefor, a gamma tuning method, and a display device, so as to solve the above problems existing in the prior art.

In order to make the above objects, features and advantages of the present disclosure be more apparent and understandable, the present disclosure will be further described below with reference to the accompanying drawings and embodiments. Example embodiments, however, can be embodied in various forms and should not be construed as limited to the embodiments set forth herein; rather, these embodiments are provided so that this disclosure will be thorough and complete, and will fully convey the concept of example embodiments to those skilled in the art. The same reference numerals in the drawings denote the same or similar structures, and thus their repeated descriptions will be omitted. The words expressing the position and direction in the present disclosure are all described by taking the accompanying drawings as examples, but changes can also be made as required, and the changes are all included in the claimed scope of the present disclosure. The drawings of the present disclosure are only used to illustrate the relative positional relationship and do not represent actual scales.

It should be noted that specific details are set forth in the following description in order to facilitate a thorough understanding of the present disclosure. However, the present disclosure can be implemented in many other ways different from those described herein, and those skilled in the art can make similar promotions without departing from the connotation of the present disclosure. Accordingly, the present disclosure is not limited by the specific embodiments disclosed below. Subsequent descriptions of the specification are preferred embodiments for implementing the present disclosure. However, the descriptions are for the purpose of illustrating the general principles of the present disclosure and are not intended to limit the scope of the present disclosure. The claimed scope of the present disclosure should be defined by the appended claims.

For better user experience, the industry has launched multi-frequency display products (i.e., products that support multiple refresh frequencies for image display), which have been mass-produced at 60/90/120 Hz. The realization of multi-frequency products (such as multi-frequency AMOLED) is mainly completed by adjusting the GOA driving signals. The highest refresh frequency of the display screen is required in the game mode.

The multi-frequency AMOLED makes the product really have good performance in some scenarios. However, in the related art, limited by the design of the display panel, the display panel can only maintain one refresh frequency at a certain moment. When a product containing a multi-frequency display panel is used by a user for playing games, the display panel is required to display images at a high refresh frequency, resulting in high power consumption of the display product.

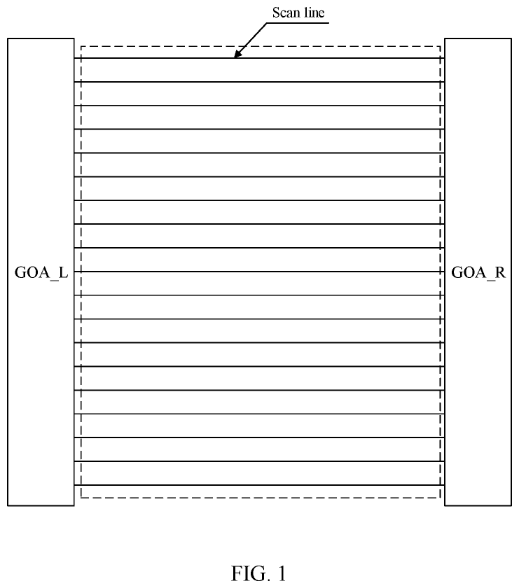

Please refer to FIG. 1, which is a schematic structural diagram of a display panel in the related art.

In FIG. 1, a region surrounded by the dotted line is a display region, and two GOA circuits, denoted as GOA_L and GOA_R, are arranged on two sides of the display region. GOA_L and GOA_R each includes multiple cascaded GOA components (not shown in FIG. 1), the GOA components of the same level in GOA_L and GOA_R are connected to two ends of a scan line, and the display panel sequentially outputs scan signals to the first row to the last row of scan lines through GOA_L and GOA_R. Therefore, in the related art, the display panel can only display the image by using one refresh frequency at a certain moment, and in the game mode, the display panel is required to display images at a high refresh frequency, resulting in the high power consumption of the display panel.

In addition, in the production of the multi-frequency display panel (that is, a display panel is provided with multiple refresh frequencies, and use one of the refresh frequencies for image display at a certain moment), since a separate gamma tuning is required for each frequency, the multi-frequency means that the tact time of gamma tuning will be multiplied, resulting in a decrease in production efficiency.

The following describes the display panel, the driving method therefor, the gamma tuning method, and the display device provided by the embodiments of the present disclosure in detail with reference to the accompanying drawings.

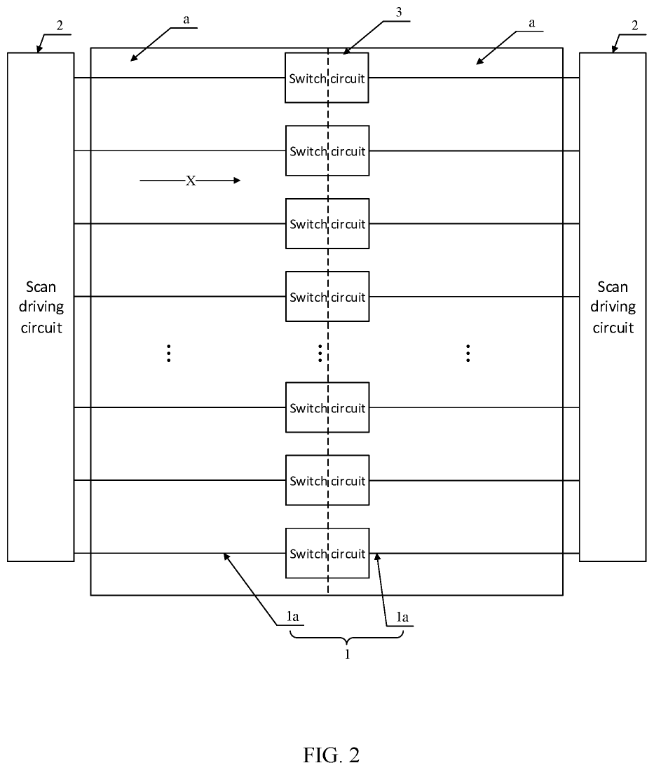

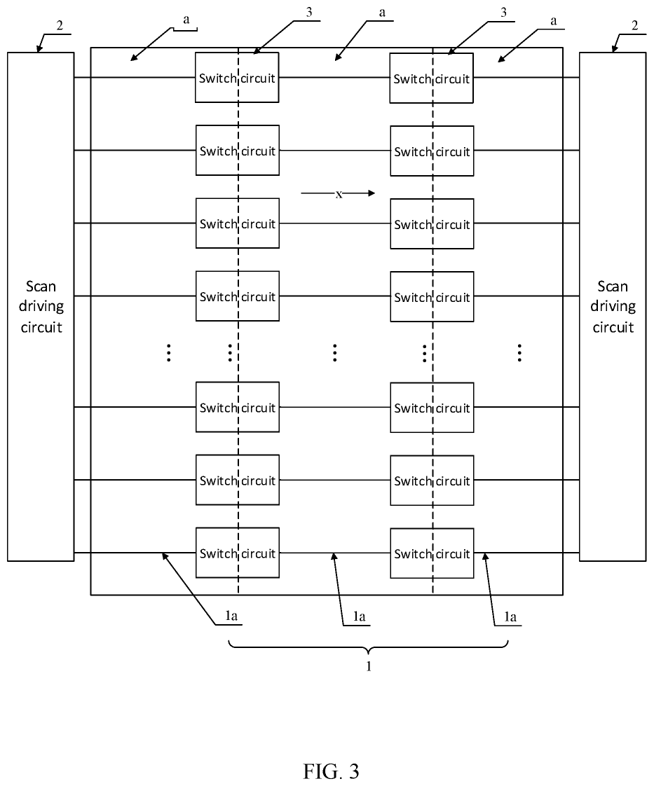

Please refer to FIGS. 2 and 3, FIG. 2 is a schematic structural diagram of a display panel according to an embodiment of the present disclosure, and FIG. 3 is a schematic structural diagram of another display panel according to an embodiment of the present disclosure.

Pixels in the display panel are arranged in an array, and the display panel includes a plurality of display sub-regions ‘a’ in a row direction X of the array. The display panel further includes:
a plurality of scan lines 1, including a plurality of scan sub-lines 1a that control the same pixel row, here the plurality of scan sub-lines 1a correspond to the plurality of display sub-regions ‘a’ one-to-one;
a plurality of scan driving circuits 2, configured to provide scan signals to corresponding pixel rows; and
a plurality of switch circuits 3, here each of the plurality of switch circuits 3 is electrically connected between two scan sub-lines adjacent to each other in the same scan line 1, and when the switch circuit 3 is configured to be in an off state, frequencies of scan signals output by the plurality of scan driving circuits 2 to at least part of different scan sub-lines 1a in the same scan line 1 are different.

In FIG. 2, the display panel includes two display sub-regions 1, and in FIG. 3, the display panel includes three display sub-regions 1. In FIGS. 2 and 3, a dotted line is used as a dividing line between two display sub-regions adjacent to each other. In FIG. 2, a scan line 1 that controls the same pixel row includes 2 scan sub-lines. In FIG. 3, a scan line 1 that controls the same pixel row includes 3 scan sub-lines 1a. The quantity of scan sub-line 1a in each display sub-region ‘a’ corresponding to one same pixel row is one, and two scan sub-lines 1a adjacent to each other are connected via one switch circuit 3.

Each display sub-region ‘a’ may correspond to one scan driving circuit 2, or only part of the display sub-regions ‘a’ each corresponds to one scan driving circuit. As shown in FIG. 3, a display sub-region ‘a’ in the middle may correspond to one scan driving circuit 2, or may share a scan driving circuit 2 with a display sub-region ‘a’ adjacent to the display sub-region ‘a’ in the middle by turning on switch circuits 3 connected to adjacent scan sub-lines.

When the plurality of switch circuits 3 shown in FIG. 2 are configured to be in an off state, a frequency of scan signals received by the scan sub-lines 1a in a display sub-region ‘a’ on the left from a corresponding scan driving circuit 2 is different from a frequency of scan signals received by the scan sub-lines 1a in a display sub-region ‘a’ on the right from a corresponding scan driving circuit 2. When the plurality of switch circuits 3 connecting two display sub-regions ‘a’ on the right are configured to be in an off state and the plurality of switch circuits 3 connecting two display sub-regions ‘a’ on the left are configured to be in an on state in FIG. 3, a frequency of scan signals received by the scan sub-lines 1a in the two display sub-regions ‘a’ on the left from a corresponding scan driving circuit(s) 2 is different from a frequency of scan signals received by scan sub-lines 1a in the right-most display sub-region ‘a’ from a corresponding scan driving circuit 2, and a display sub-region ‘a’ in the middle can also share the scan driving circuit 2 with the left-most display sub-region ‘a’. Further, all the switch circuits 3 in FIG. 3 may be set to be in the off state, and in such a condition, the scan driving circuits 2 corresponding to at least two adjacent display sub-regions ‘a’ output the scan signals with different frequencies to the corresponding scan sub-lines 1a.

Similarly, when the display panel includes more display sub-regions ‘a’ in the row direction X, it can be deduced by analogy, and details are not repeated.

It should be noted that, in FIGS. 2 and 3, pixels connected to each scan line 1 are not shown. Further, there may be only a part of the scan lines 1 in FIGS. 2 and 3 which are provided with multiple scan sub-lines 1a. For example, each of the last 50 pixel rows corresponds to one scan line 1, and the one scan line 1 does not include scan sub-lines 1a. The scan line 1 that does not include scan sub-lines 1a may use a separate scan driving circuit 2, or may share one scan driving circuit 2 with a certain display sub-region ‘a’.

In embodiments provided by the present disclosure, multiple scan lines 1 each include multiple scan sub-lines 1a that control the same pixel row, and the multiple scan sub-lines 1a correspond to multiple display sub-regions one-to-one. The switch circuit 3 is arranged between two adjacent scan sub-lines 1a in the same scan line 1. When the switch circuit 3 is configured to be in an off state, the frequencies of the scan signals output by the multiple scan driving circuits 2 to at least some of the different scan sub-lines 1a in the same scan line 1 are controlled to be different, so that the display panel can display the images by using a variety of different refresh frequencies at the certain moment. When the display panel works in the game mode, the game image can be displayed at the high refresh frequency, while the image of the control part (such as the virtual button) can be displayed at the low refresh frequency, and therefore there is no need for the entire image to be displayed at the high refresh frequency as in the prior art, so as to effectively reduce the power consumption of the display panel.

In possible implementations, multiple switch circuits 3 between two adjacent display sub-regions ‘a’ are in a linear arrangement.

As shown in FIG. 2 or 3, the linear arrangement includes a linear arrangement in which the switch circuits are arranged in a straight line parallel to a column direction.

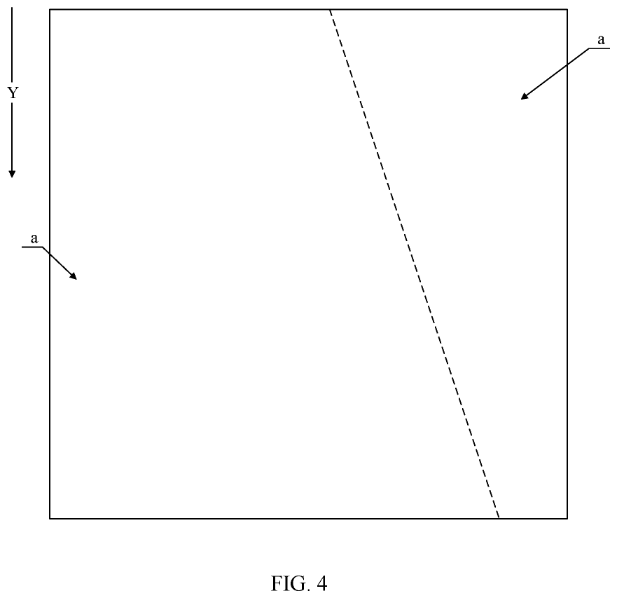

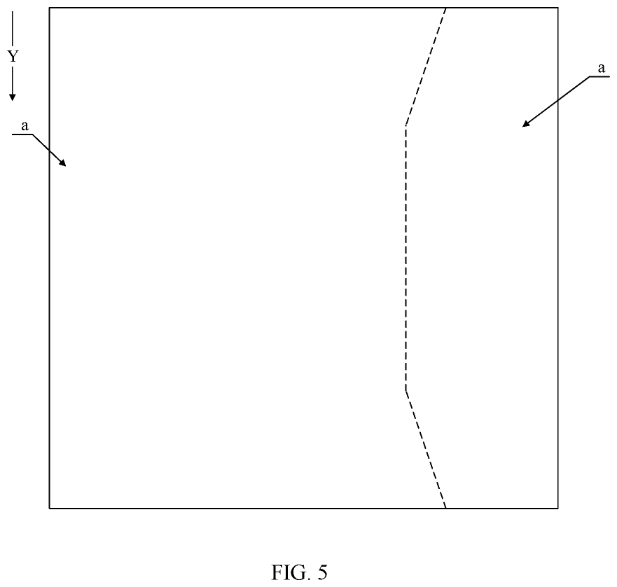

Referring to FIGS. 4 and 5, FIG. 4 is a schematic diagram of multiple switch circuits in an oblique line arrangement according to an embodiment of the present disclosure, and FIG. 5 is a schematic diagram of multiple switch circuits in a linear arrangement according to an embodiment of the present disclosure.

As shown in FIG. 4, the linear arrangement includes an oblique line arrangement in which the switch circuits are arranged in an oblique line intersecting the column direction Y.

As shown by the dotted lines (illustrating the multiple switch circuits 3) in FIGS. 4 and 5, the display region of the display panel is divided into two display sub-regions ‘a’ by the multiple switch circuits 3. The multiple switch circuits 3 may be in the oblique arrangement as shown in FIG. 4, or in the folded line arrangement as shown in FIG. 5.

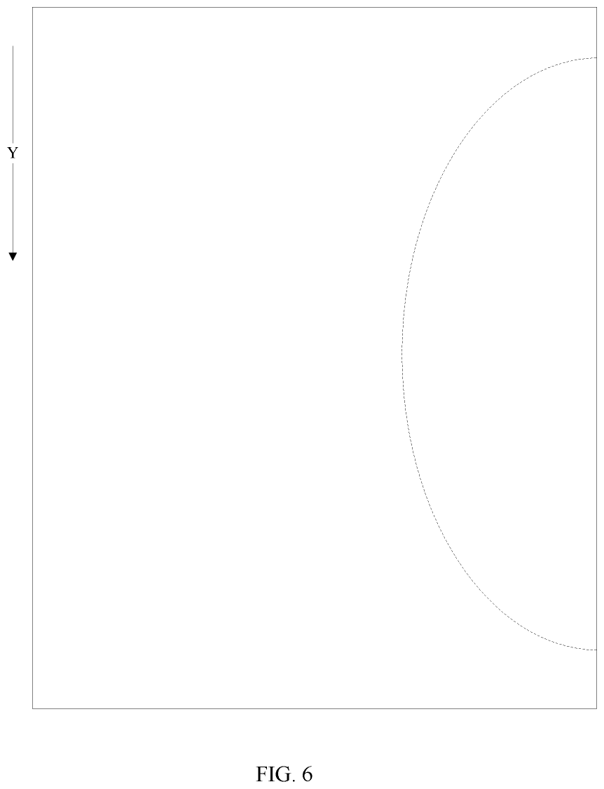

Please refer to FIG. 6, which is a schematic diagram of multiple switch circuits in a non-linear arrangement according to an embodiment of the present disclosure.

As shown in FIG. 6, multiple switch circuits 3 between two adjacent display sub-regions ‘a’ are in a non-linear arrangement.

It should be noted that multiple switch circuits 3 between two adjacent display sub-regions ‘a’ are not limited to the arrangements in the above figures, and may also be other arrangements.

By arranging multiple switch circuits 3 between two adjacent display sub-regions ‘a’ in a linear or non-linear arrangement, the display panel can be customized according to customer requirements, so that the image of the control part in the game mode can be displayed in a specific region consisting of one display sub-region ‘a’ or multiple display sub-regions ‘a’ adjacent to each other in the display panel, so as to carry out personalized customization.

In possible implementations, the areas of the multiple display sub-regions ‘a’ are different. Please continue to refer to FIGS. 4 to 6, the areas of the multiple display sub-regions ‘a’ can be different, so that the display sub-regions ‘a’ that meet the customer's requirements can be customized according to the customer's requirements, so as to realize personalized customization.

In possible implementations, the areas of the multiple display sub-regions ‘a’ are the same.

Please continue to refer to FIGS. 2 and 3, the areas of the multiple display sub-regions ‘a’ can also be the same, which is convenient for mass production and meets the requirements of most customers. Please continue to refer to FIG. 3, when the quantity of multiple display sub-regions ‘a’ is greater than 2 and their areas are the same, the on and off states of multiple switch circuits 3 between two adjacent display sub-regions ‘a’ can be controlled by the customer to change the areas occupied by the scan signals with different frequencies, so that the areas occupied by the scan signals with different frequencies can be freely set by the customer, which can meet the personalized requirements of the customer while mass production is achieved.

Since multiple switch circuits 3 are included in the display panel, images can be displayed by the display panel at different refresh frequencies at the same time, so that when gamma tuning (brightness correction) is performed on the display panel, the gamma tuning performed on the display panel can be completed at different refresh frequencies at the same time, so as to effectively reduce the tact time of the display panel and improve the production efficiency.

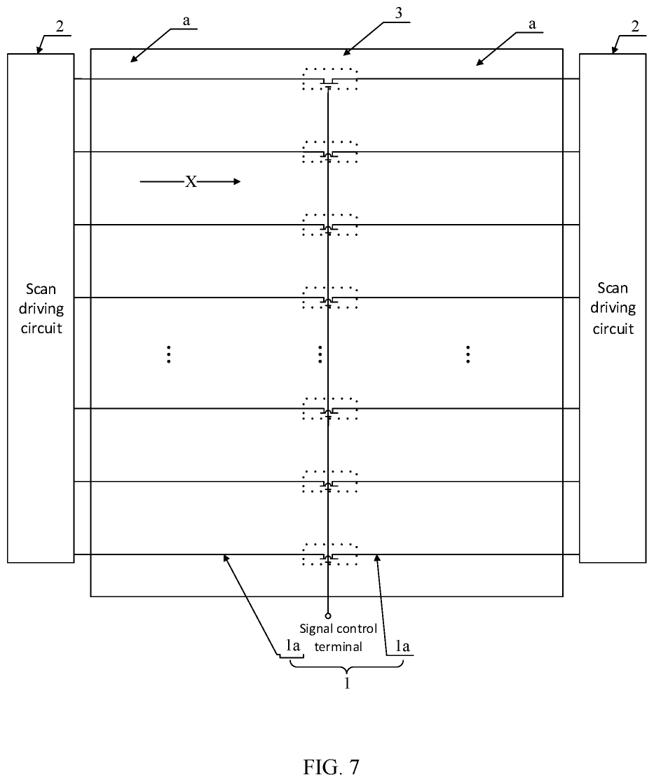

Please refer to FIG. 7, which is a schematic structural diagram of another display panel according to an embodiment of the present disclosure.

The switch circuit 3 includes a thin film transistor, and a first terminal and a second terminal of the thin film transistor are electrically connected to one terminal of one of two adjacent scan sub-lines 1a in the scan line 1 and one terminal of the other one of the two adjacent scan sub-lines 1a.

Control terminals of multiple thin film transistors are electrically connected to the same one signal control terminal.

The thin film transistor may be an N-type thin film transistor or a P-type thin film transistor.

By setting the switch circuit 3 as the thin film transistor, the switch circuit 3 can be manufactured by using the original materials for manufacturing the display panel without adding other materials.

By electrically connecting control electrodes of multiple thin film transistors to the same one signal control terminal, it is convenient to quickly set the multiple thin film transistors to the off or on state at the same time.

Based on the same inventive concept, embodiments of the present disclosure provide a driving method for a display panel, including:
setting, according to a quantity of types of frequencies of the scan signals outputted by the plurality of scan driving circuits in the display panel for a same frame image, working states of the plurality of switch circuits; here the working states include the on state or off state.

For example, taking FIG. 2 as an example, the display panel shown in FIG. 2 includes two display sub-regions, i.e., left and right display sub-regions ‘a’, each of which corresponds to one scan driving circuit 2.

When an image needs to be displayed in the entire display region of the display panel at a refresh frequency of 60 Hz, the frequencies of the scan signals output by the two scan driving circuits 2 are both 60 Hz. The plurality of switch circuits 3 is set to the on state before the two scan driving circuits 2 start outputting the scan signals. Then the two scan driving circuits are controlled to simultaneously start outputting the scan signals with the frequency of 60 Hz.

When images needs to be simultaneously displayed in different display sub-regions ‘a’ of the display region of the display panel at the refresh frequencies of 60 Hz and 120 Hz, the frequencies of the scan signals output by the two scan driving circuits 2 are 60 Hz and 120 Hz respectively. Before the two scan driving circuits 2 are controlled to start outputting the scan signals, the plurality of switch circuits 3 are set to the off state. Then the two scan driving circuits are controlled to simultaneously start outputting the scan signals with the frequencies 60 Hz and 120 Hz respectively.

In possible implementations, the setting, according to the quantity of types of frequencies of the scan signals outputted by the plurality of scan driving circuits in the display panel for the same frame image, the working states of the plurality of switch circuits, including:
setting, when the quantity of types of frequencies of the scan signals outputted by the plurality of scan driving circuits in the display panel for the same frame image is one, the working states of the plurality of switch circuits to the on state.

In possible implementations, the setting, according to frequencies of the scan signals outputted by the plurality of scan driving circuits in the display panel for the same frame image, the working states of the plurality of switch circuits, including:
setting, when frequencies of the scan signals outputted by the plurality of scan driving circuits in the display panel for the same frame image are different, the working states of the plurality of switch circuits to the off state.

In possible implementations, the setting, when the quantity of types of frequencies of the scan signals outputted by the plurality of scan driving circuits in the display panel for the same frame image is multiple, the working states of the plurality of switch circuits to the off state including:
setting, when the quantity of types is equal to a quantity of the plurality of display sub-regions, the working states of all the plurality of switch circuits to the off state;
when the quantity of types is less than a quantity of the display sub-regions: setting working states of switch circuits between adjacent display sub-regions in which frequencies of scan signals are the same to the on state, and working states of switch circuits between adjacent display sub-regions in which frequencies of scan signals are different to the off state.

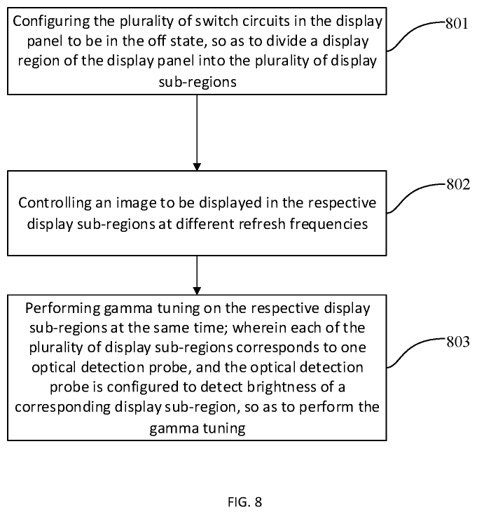

Based on the same inventive concept, embodiments of the present disclosure provide a gamma tuning method based on the above-mentioned display panel. Please refer to FIG. 8, which a flowchart of a gamma tuning method for the display panel provided by embodiments of the present disclosure, including:
step 801: configuring the plurality of switch circuits in the display panel to be in the off state, so as to divide a display region of the display panel into the plurality of display sub-regions;
step 802: controlling an image(s) to be displayed in the respective display sub-regions at different refresh frequencies;
step 803: performing gamma tuning on the respective display sub-regions at the same time; here each of the plurality of display sub-regions corresponds to one optical detection probe, and the optical detection probe is configured to detect brightness of the corresponding display sub-region, so as to perform the gamma tuning.

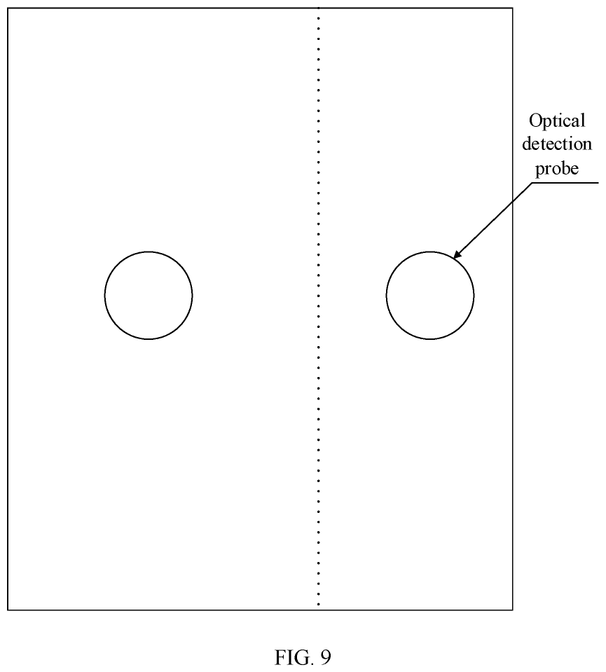

Please refer to FIG. 9, which is a schematic diagram of a corresponding relationship between optical detection probes and display sub-regions of the display panel according to an embodiment of the present disclosure.

In the display panel shown in FIG. 9, by setting multiple switch circuits to the off state, the display panel can be divided into two display sub-regions on the left and right (the dividing line between the two display sub-regions is shown by the dotted line in the figure, also is the arrangement position of the switch circuits).

In this way, when gamma tuning (brightness correction) is performed on the display panel, one optical detection probe can be set for each of the two display sub-regions to collect the brightness of the corresponding display sub-region, and then gamma tuning is performed on the respective display sub-regions at the same time according to the collected brightness of the respective display sub-regions and the actual brightness displayed in the respective display sub-regions. Since gamma tuning can be performed on the display panel at different refresh frequencies at the same time, it is not necessary to perform gamma tuning at each refresh frequency one by one as in the prior art, which can effectively reduce the tact time of the gamma tuning for the multi-frequency display panel and improve the production efficiency.

It should be noted that, since the manner of performing gamma tuning on the display sub-region is the same as that in the related art when displaying with a single refresh frequency, the details of how to perform the gamma tuning on the display sub-region will not be repeated.

Based on the same inventive concept, embodiments of the present disclosure provide a display device including the above-mentioned display panel.

The display device can be a display device such as an AMOLED display, an AMOLED display screen, an AMOLED TV, etc., or a mobile device such as a mobile phone, a tablet computer, and a notebook, etc.

While the preferred embodiments of the present disclosure have been described, additional changes and modifications to these embodiments may occur to those skilled in the art once the basic inventive concepts are appreciated. Therefore, the appended claims are intended to be construed to include the preferred embodiments and all changes and modifications that fall within the scope of the present disclosure.

It will be apparent to those skilled in the art that various modifications and variations can be made to the present disclosure without departing from the spirit and scope of the present disclosure. Thus, provided that these modifications and variations of the present disclosure fall within the scope of the claims of the present disclosure and their equivalents, the present disclosure is also intended to cover such modifications and variations.

1. A display panel, wherein pixels in the display panel are arranged in an array, the display panel comprises a plurality of display sub-regions in a row direction of the array, and the display panel further comprises:
a plurality of scan lines, comprising a plurality of scan sub-lines that control a same pixel row, wherein the plurality of scan sub-lines correspond to the plurality of display sub-regions one-to-one;
a plurality of scan driving circuits, configured to provide scan signals to corresponding pixel rows; and
a plurality of switch circuits, wherein each of the plurality of switch circuits is electrically connected between two scan sub-lines adjacent to each other in a same scan line, and when the switch circuit is configured to be in an off state, frequencies of scan signals output by the scan driving circuits to at least part of different scan sub-lines in the same scan line are different.

2. The display panel according to claim 1, wherein multiple switch circuits, of the plurality of switch circuits, between two display sub-regions adjacent to each other are in a linear arrangement.

3. The display panel according to claim 12, wherein the linear arrangement comprises arrangement along a line parallel to a column direction of the array.

4. The display panel according to claim 3, wherein the linear arrangement comprises arrangement along an oblique line intersecting the column direction.

5. The display panel according to claim 1, wherein multiple switch circuits, of the plurality of switch circuits, between two display sub-regions adjacent to each other are in a non-linear arrangement.

6. The display panel according to claim 1, wherein areas of at least part of the plurality of display sub-regions are different.

7. The display panel according to claim 1, wherein areas of all of the plurality of display sub-regions are same.

8. The display panel according to claim 1, wherein the switch circuit comprises a thin film transistor, and a first terminal and a second terminal of the thin film transistor are electrically connected to one terminal of one of the two scan sub-lines adjacent to each other in the scan line and one terminal of another one of the two scan sub-lines.

9. The display panel according to claim 8, wherein control terminals of multiple thin film transistors between two display sub-regions adjacent to each other are electrically connected to a same signal control terminal.

10. A driving method for a display panel according to claim 1, comprising:
setting, according to a quantity of types of frequencies of the scan signals outputted by the plurality of scan driving circuits in the display panel for a same frame image, working states of the plurality of switch circuits; wherein the working state comprise an on state or an off state.

11. The driving method according to claim 10, wherein the setting, according to the quantity of types of frequencies of the scan signals outputted by the plurality of scan driving circuits in the display panel for the same frame image, the working states of the plurality of switch circuits comprises:
setting, when the quantity of types of frequencies of the scan signals outputted by the plurality of scan driving circuits in the display panel for the same frame image is one, the working states of the plurality of switch circuits to the on state.

12. The driving method according to claim 10, wherein the setting, according to the quantity of types of frequencies of the scan signals outputted by the plurality of scan driving circuits in the display panel for the same frame image, the working states of the plurality of switch circuits comprises:
setting, when the quantity of types of frequencies of the scan signals outputted by the plurality of scan driving circuits in the display panel for the same frame image is multiple, the working states of at least part of the plurality of switch circuits to the off state.

13. The driving method according to claim 12, wherein the setting, when the quantity of types of frequencies of the scan signals outputted by the plurality of scan driving circuits in the display panel for the same frame image is multiple, the working states of at least part of the plurality of switch circuits to the off state comprises:
setting, when the quantity of types is equal to a quantity of the plurality of display sub-regions, working states of all the plurality of switch circuits to the off state; or
when the quantity of types is less than a quantity of the display sub-regions: setting working states of switch circuits between adjacent display sub-regions in which frequencies of scan signals are same to the on state, and working states of switch circuits between adjacent display sub-regions in which frequencies of scan signals are different to the off state.

14. A gamma tuning method for a display panel according to claim 1, comprising:
configuring the plurality of switch circuits in the display panel to be in an off state, so as to divide a display region of the display panel into the plurality of display sub-regions;
controlling an image to be displayed in the respective display sub-regions at different refresh frequencies; and
performing gamma tuning on the respective display sub-regions at the same time; wherein each of the plurality of display sub-regions corresponds to one optical detection probe, and the optical detection probe is configured to detect brightness of a corresponding display sub-region, so as to perform the gamma tuning.

15. A display device, comprising the display panel according to claim 1.
